(19) United States
(12) Patent Application Publication
(10) Pub. No.: US 2013/0301179 A1
(43) Pub. Date: Nov. 14, 2013

(54) Discrete Silicon Avalanche Diode Array

(71) Applicant: Holliday Scott, Sugar Land, TX (US)

(72) Inventor: Holliday Scott, Sugar Land, TX (US)

(21) Appl. No.: 13/893,185

(22) Filed: May 13, 2013

Related U.S. Application Data
(60) Provisional application No. 61/646,148, filed on May 11, 2012.

(51) Int. Cl. H02H 9/00

(52) U.S. Cl. CPC H02H 9/005
USPC 361/111

(57) ABSTRACT

A transient surge protector with discrete silicon avalanche diode arrays is closed. The transient surge protector comprises one or more pairs of stacks of discrete silicon avalanche diode arrays. Each diode array comprises three silicon avalanche diodes. The discrete silicon avalanche diode arrays may be mounted to an epoxy coated glass epoxy circuit board. The transient surge protector with discrete silicon avalanche diode array disclosed herein provides passive transient surge protection for both 24V-DC and communication loops. Applications of the transient surge protector include both discrete and process automation instrumentation.

### CROSS-REFERENCE TO RELATED APPLICATIONS

This Application claims priority to U.S. Provisional Application Ser. No. 61/646,148 entitled “Discrete Silicon Avalanche Diode Array” filed May 11, 2012, which is hereby incorporated by reference in its entirety.

### BACKGROUND

This disclosure relates to transient surge protectors, more particularly, to a transient surge protector with improved characteristics.

Transient activity is believed to account for 80% of all electrically-related downtime. Transients are momentary changes in voltage or current that occur over a short period of time. Transients can be generated internally, such as device switching, static discharge, and arching, etc. Transients can also come into a facility from outside source, such as lightning or power provided by the power company.

Conventionally, a transient surge protector is employed to protect electrical devices from transient voltages. A transient surge protector attempts to limit the voltage supplied to an electrical device by either blocking or by shorting the ground any unwanted voltages above a safe threshold. Typically, an MOV (metal oxide varistor) or GDT (gas discharge tube) is incorporated into a transient surge protector.

An MOV if formed by subjecting zinc oxide and bismuth oxide to sintering. An MOV has properties of having a high resistance when voltage applied thereto is high. Resistance of an MOV may decreases greatly to pass a great amount of current through when applied voltage is greater than its safe threshold. However, there are several issues to be noted regarding behavior of transient voltage surge protectors incorporating MOVs under over-voltage conditions. Depending on the level of conducted current, dissipated heat may be insufficient to cause failure, but may degrade the MOV device and reduce its life expectancy. If excessive current is conducted by an MOV, it may fail catastrophically, keeping the load connected, but now without any surge protection. A user may have no indication when the surge suppressor has failed. MOV based surge protectors also tend to have slow response time, and variable and inconsistent clamping ability. Using this technology can prove costly as it continually weakens with transient surges. It is a very high maintenance item due to the necessity of checking the resistance of the MOV to assure protection strength.

Another widely used transient surge protection device is a Hybrid based surge protector, typically a single silicon diode, an MOV, and a GDT mounted in housing. A silicon diode provides the fastest limiting action of protective components, but has a relatively low energy absorbing capability. Voltages can be clamped to less than twice the normal operation voltage. If component ratings are exceeded, the diode may fail as a permanent short circuit; in such cases, protection may remain but normal circuit operation is terminated in the case of low-power signal lines. A GDT is a sealed glass-enclosed device containing a special gas mixture trapped between two electrodes, which conduct electric current after becoming ionized by a high voltage spike. However, GDTs take a relatively long time to trigger, permitting a higher voltage spike to pass through before the GDT conducts significant current. In a hybrid based surge protector, the single silicon diode is the first line of defense. However, a single silicon diode does not have a very high level of current handling capability. Once the diode is sacrificed, the device is left with the MOV and the gas tube, thus has the same flaws as the MOV based surge protectors.

### SUMMARY OF THE INVENTION

It is therefore one objective of the invention to provide a surge protector which provides fast response time, repeatable voltage clamping level, and non-degradability.

The transient surge protector disclosed herein comprises one or more pairs of stacks of discrete silicon avalanche diode arrays. Each diode array comprises three silicon avalanche diodes. The discrete silicon avalanche diode arrays may be mounted to an epoxy coated glass epoxy circuit board. The transient surge protector provides quick response time and repeatable protection for field instrumentation without degrading. The transient surge protector with discrete silicon avalanche diode array disclosed herein may be used provide passive transient surge protection for both 24VDC and communication loops.

### BRIEF DESCRIPTION OF THE DRAWINGS

The following combination of drawings to detailed description of specific embodiments of the present invention.

FIG. 1 is a detailed schematic view of a transient surge protector with discrete silicon avalanche arrays, according to some embodiments;

FIG. 2 is a schematic view of an example application of the transient surge protector of FIG. 1, according to some embodiments;

FIG. 3 is a schematic view of another example application of the transient surge protector of FIG. 1, according to some embodiments;

FIG. 4 is a schematic view of yet another example application of the transient surge protector of FIG. 1, according to some embodiments.

### DETAILED DESCRIPTION OF THE INVENTION

In accordance with the embodiments described herein, a transient surge protector with discrete silicon avalanche diode arrays is closed. The discrete silicon avalanche diode arrays are mounted to an epoxy coated glass epoxy circuit board. The transient surge protector with discrete silicon avalanche diode array disclosed herein provides passive transient surge protection for both 24VDC and communication loops. Applications of the transient surge protector include both discrete and process automation instrumentation.

In the following detailed description, for purposes of explanation, numerous specific details are set forth in order to provide a thorough understanding of the invention. It will be apparent to one skilled in the art, however, that the invention may be practiced without these specific details. In other instances, structure and devices are shown in block diagram form in order to avoid obscuring the invention. It will be appreciated that in the development of any actual implementation (as in any development project), numerous decisions must be made to achieve the developers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the art having the benefit of this disclosure. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

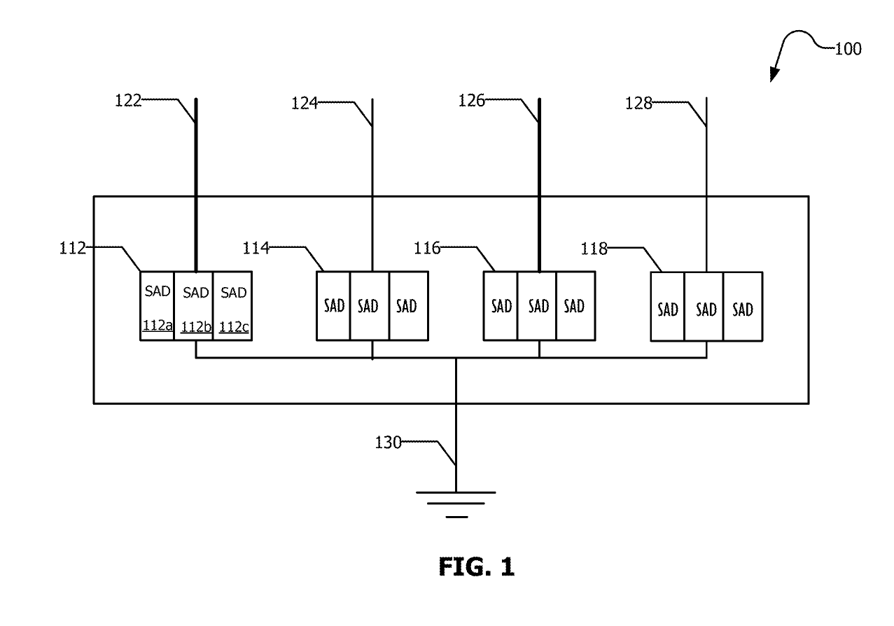

Referring now to FIG. 1, a transient surge protector with discrete silicon avalanche diode arrays in accordance with a preferred embodiment of the invention is shown. The transient surge protector 100 comprises two pairs of two stacks of discrete silicon avalanche diode (SAD) arrays 112, 114, and 116, 118. In accordance with some embodiments, the surge protector 100 may comprise just one pair of stacks of silicon avalanche diode arrays, or multiple pairs of SAD arrays. Each stack of SAD arrays may comprise multiple silicon avalanche diodes. As shown in FIG. 1, the stack of SAD arrays 112 comprises three 16 volt (+/−5%) RoHS compliant silicon avalanche diodes 112a, 112b, and 112c that are cut from the silicon wafer. A copper header is used between each of the diode dies and then low-inductance “Banjo Leads” is used at end of the stack.

In accordance with one embodiment, the discrete silicon avalanche diode arrays are mounted to an epoxy coated glass epoxy circuit board to form a transient surge protector. The epoxy coated glass epoxy circuit board can be very small. In accordance with one embodiment, the dimensions of the transient surge protector are: 22 mm×17 mm×6.8 mm. The disclosed transient surge protector 100 is small enough to be mounted inside the instrument housing allowing the surge protector to protect instrumentation located in hazardous areas. This surge protector 100 can be mounted into an explosion proof housing allowing it to be used in a Class 1, Division 1 or into a suitable enclosure for Class 1, Division 2 locations. In accordance with one embodiment, the transient surge protector 100 is mounted into a ¾″ LBY. In accordance with another embodiment, the transient surge protector 100 is mounted into a GUA outlet box. In accordance with yet another embodiment, the transient surge protector 100 is mounted into transmitter housing.

The transient surge protector 100 may comprise at least three terminal, one or more signal input terminals, typically in red color, shown as terminal 122 and terminal 126, one or more signal output terminals, typically in white color, which may be electrically connected to the return line of the power supply, shown as terminal 124 and terminal 128, and a grounding terminal, typically in green color, shown as terminal 130. Signal input terminal or signal output terminal may be electrically connected to the supply line or the return line of the power supply to protect a certain electrical device. Each of the signal input terminals and signal output terminals is connected to a stack of SAD arrays. All of the stacks of SAD arrays bound to the grounding terminal 130. In accordance with some embodiments, all terminals of the transient surge protector 100 use 12″ stranded wire leads. The color scheme of the signal terminals is for the convenience of use only, a red color terminal may also be used as a signal output terminal, and a white color terminal may be used as a signal input terminal as well.

The transient surge protector with discrete silicon avalanche arrays disclosed herein provides quick response time and repeatable protection for field instrumentation without degrading. When silicon avalanche diodes are stacked in an array, they provide faster response time as well as robust protection without degrading. In accordance with some embodiments, the response time is less than 5 nanoseconds. Because the transient surge protector utilizes non-degrading technology, the surge protector is either at 100% protection status or 0% (no protection). Therefore it is not necessary to use maintenance hours to check the device. If the surge protector is at 0%, the transient surge protector 100 has self-sacrificed to protect the instrument and will Fail Short.

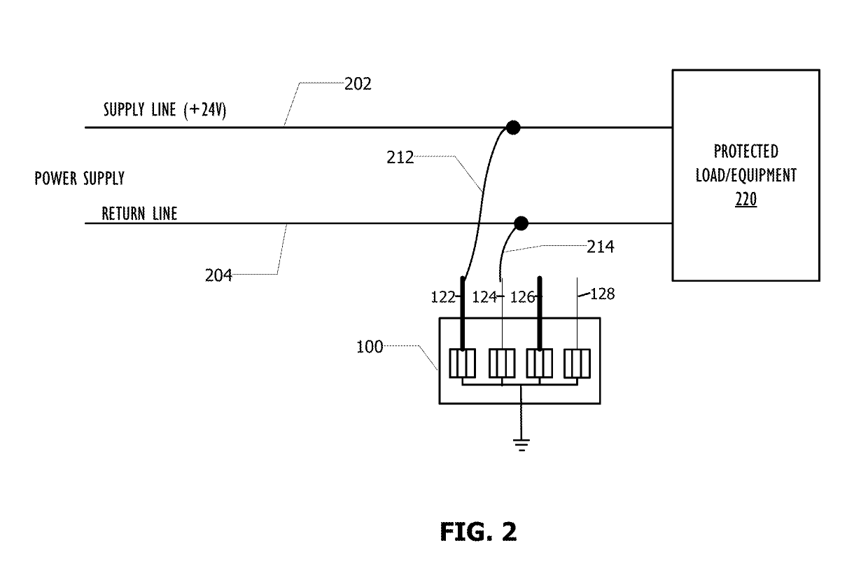

Referring now to FIGS. 2-4, example applications of the transient surge protector 100 are shown. FIG. 2 illustrates one exemplary application of the transient surge protector 100 to protect electric load or equipment in DC 24V environment. Load/Equipment 220 to be protected is connected to the power supply. The transient surge protector 100 is then connected to the power supply in parallel to protected Load/Equipment 220, and is placed in between the power supply and the protected Load/Equipment 220. Terminal 122 is electrically connected to the supply line 202 of the power supply, shown as connection 212 in FIG. 2; terminal 124 is connected to the return line 204 of the power supply, shown as connection 214. Terminals 126 and 128 are left open.

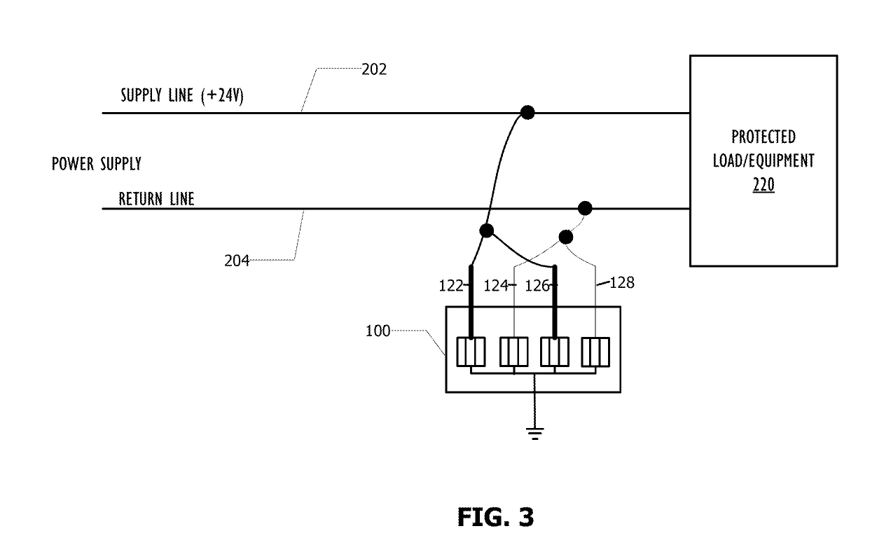

FIG. 3 illustrates another exemplary application of the transient surge protector 100 to protect electric load or equipment in DC 24V environment. As shown in FIG. 3, Load/Equipment 220 to be protected is connected to the power supply. The transient surge protector 100 is then connected to the power supply in parallel to protected Load/Equipment 220, and is placed in between the power supply and the protected Load/Equipment 220. Terminal 122 and terminal 126 are electrically connected to the supply line 202 of the power supply; terminal 124 and terminal 128 are electrically connected to the return line 204 of the power supply.

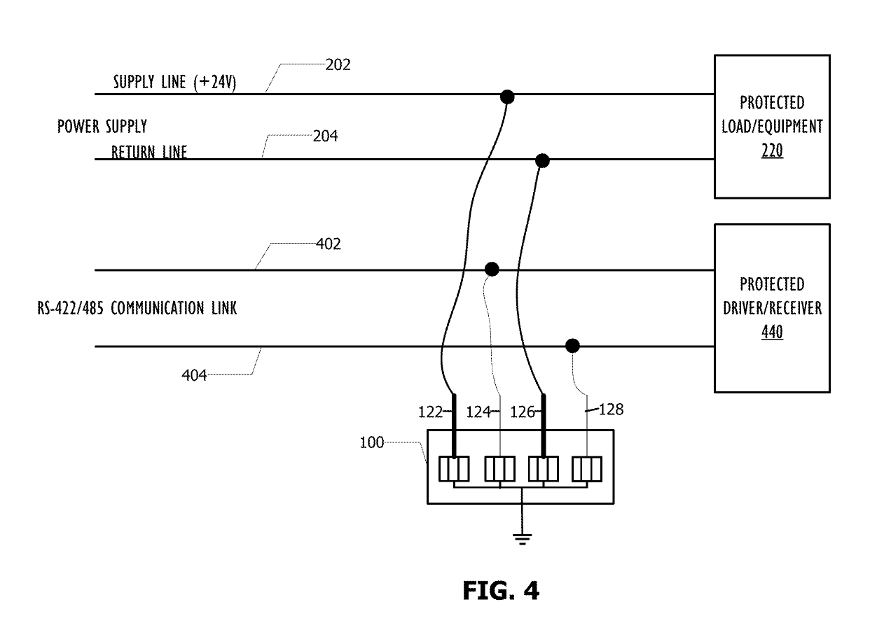

FIG. 4 illustrates yet another exemplary application of the transient surge protector 100 to protect 24V DC power and RS-422/485, RS232, or 4-20 mA communication loop. As shown in FIG. 4, terminal 122 and terminal 126 are electrically connected to the supply line 202 and return line 204 of the power supply respectively before the protected Load/Equipment 220; terminal 124 and terminal 128 are electrically connected to the lines 402 and 404 of RS-422/485, RS232, or 4-20 mA communication link before the protected Driver/Received 440.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A transient surge protector electrically connected to a power supply for protecting an electrical device connected to the power supply from harmful electrical disturbances, the transient surge protector comprises:
one or more pairs of stacks of discrete silicon avalanche diode arrays;
for each pair of stacks of discrete silicon avalanche diode arrays, a signal input terminal connected to one stack of discrete silicon avalanche diode arrays, and a signal output terminal connected to the other stack of the discrete silicon avalanche diode arrays; and
a grounding terminal referenced by all of the one or more pairs of stacks of discrete silicon avalanche diode arrays.

2. The transient surge protector of claim 1, wherein the one or more pairs of stacks of discrete silicon avalanche diode arrays are mounted to an epoxy coated glass epoxy circuit board.

3. The transient surge protector of claim 1, wherein the number of the pairs of stacks of discrete silicon avalanche diode arrays is 2.

4. The transient surge protector of claim 1, wherein each stack of discrete silicon avalanche arrays comprising three RoHS complaint silicon avalanche diodes.

5. The transient surge protector of claim 1, wherein the surge protector has a response time of less than 5 nanoseconds.

6. The transient surge protector of claim 1, wherein the power supply is a 24V-DC power.

7. The transient surge protector of claim 1, wherein or more signal input terminals are electrically connected to a supply line of the power supply, and one or more signal output terminals are electrically connected to a return line of the power supply, the electrical device is electrically connected in parallel to the surge protector after the surge protector.

8. The transient surge protector of claim 3, wherein one signal terminal is electrically connected to a supply line of the power supply, one signal terminal is electrically connected to a return line of the power supply, one signal terminal is electrically connected to a supply line of a RS-422/485, RS232, or 4-20 mA communication link, one signal terminal is electrically connected to a return line of the RS-422/485, RS232, or 4-20 mA communication link, the electrical device is electrically connected to the power supply in parallel to the surge protector after the surge protector, and a driver or receiver is electrically connected to the RS-422/485, RS232, or 4-20 mA communication line in parallel to the surge protector after the surge protector.

9. The transient surge protector of claim 1, wherein the surge protector is mounted into an explosion proof housing.
